(19) United States
(12) Patent Application Publication
(10) Pub. No.: US 2012/0286731 A1
(43) Pub. Date: Nov. 15, 2012

(54) BATTERY CHARGER

(75) Inventors: TING GONG, Shenzhen City (CN); SHA-SHA HU, Shenzhen City (CN); BO-CHING LIN, Tu-Cheng (TW); TING DONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/187,521

(22) Filed: Jul. 21, 2011

(30) Foreign Application Priority Data
May 12, 2011 (CN) 201110122356.9

(51) Int. Cl. H02J 7/02

(52) U.S. Cl. 320/111

(57) ABSTRACT

A battery charger includes a base, a plug formed on the base and electrically connected to an external power source, an interface formed on the base and electrically connecting an external device, a clamp formed on the base and fixing and electrically connecting a battery, and a controller embedded in the base and electrically connected to the plug, the clamp, and the interface. The controller is able to boost the battery voltage to a rated charging voltage of the external device and conducting the voltage to the interface to charge the external device.

### BACKGROUND

1. Technical Field

The present disclosure relates to battery chargers, particularly, to a battery charger capable of charging an external electronic device even when no external power source is available.

2. Description of Related Art

Generally, battery chargers are connected to an external power source to charge a battery of an electronic device. However, when there is no available power source, such as, when the user is travelling on a train, and his or her mobile phone runs out of power, the battery charger is not usable to charge the mobile phone, which is inconvenient for the user.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a battery charger in accordance with an exemplary embodiment.

FIG. 2 is a schematic view showing current paths of the battery charger of FIG. 1.

FIG. 3 is a block diagram of a circuit board of the battery charger of FIG. 1.

### DETAILED DESCRIPTION

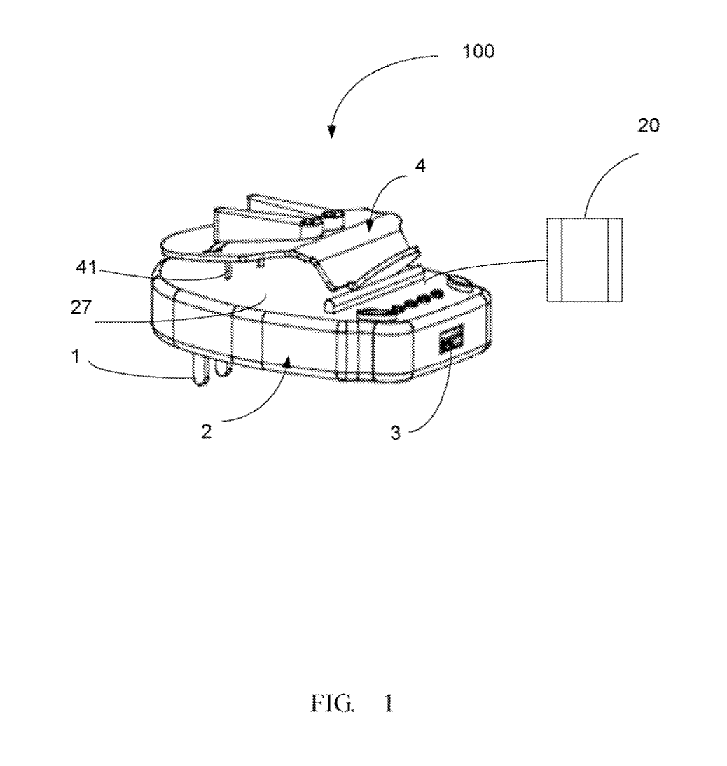

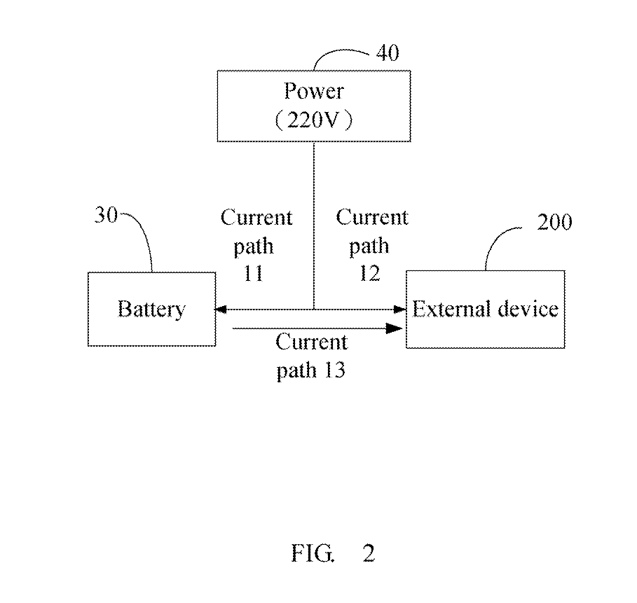

Referring to FIGS. 1 and 2, a battery charger 100 includes a plug 1 configured to electrically connect to an external power source 40, a base 2, an interface 3 configured to electrically connect an external device 200, a clamp 4 configured to fix a battery 30, and a controller 20 embedded in the base 2. The plug 1 and the interface 3 are mounted on the base 2 and electrically connect to the controller 20. In the embodiment, the interface 3 is a USB interface. One end of the clamp 4 is rotatably connected to the base 2, and the other end of the clamp 4 is installed with pins 41. The pins 41 are electrically connected to the controller 20. The base 2 has a receiving area 27 for receiving a battery 30. When the battery 30 is received in the receiving area 27 correctly, the pins 41 of the clamp 4 abut the battery 30 and electrically connect to the electrodes of the battery 30.

Referring to FIG. 2, in the embodiment, the battery charger 100 includes a first current path 11, a second current path 12, and a third current path 13. The first current path 11 is defined by the plug 1, the controller 20, and the pins 40. Via the current path 11, power supplied by the power source 40 charges the battery 30. The second current path 12 is defined by the plug 1, the controller 20, and the interface 3. Via the current path 12, power supplied by the power source 40 can charge an external device 200. The third current path 13 is defined by the pins 41, the controller 20 and the interface 3. Via the current path 13, power from the battery 30 can charge the external device 200. The controller 20 controls conduction of the three current paths 11, 12, and 13. In the embodiment, when the first current path 11 and the second current path 12 are closed, the third current path 13 is opened.

When the plug 1 is electrically connected to the power source 40, the battery 30 is received in the receiving area 27 correctly, and the interface 3 is not connected to the external device 200, the controller 20 closes the first current path 11 to charge the battery 30. When the plug 1 is electrically connected to the power source 40, the battery 30 is not received in the receiving area 27 correctly, and the charging interface 3 is connected to the external device 200, the controller 20 closes the second charged path 12 to charge the external device 200. When the plug 1 is electrically connected to the power source 40, the battery 30 is received in the receiving area 27 correctly, and the interface 3 is connected to the external device 200, the controller 20 closes the first charged path 11 and the second charged path 12 to charge the battery 30 and the external device 200 and opens the third charged path 13. When the plug 1 is not electrically connected to the power 40, the battery 30 is received in the receiving area 27 correctly, and the charging interface 3 is connected to the external device 200, the charging controller 20 closes the third current path 13 to charge the external device 200 using power from the battery 30.

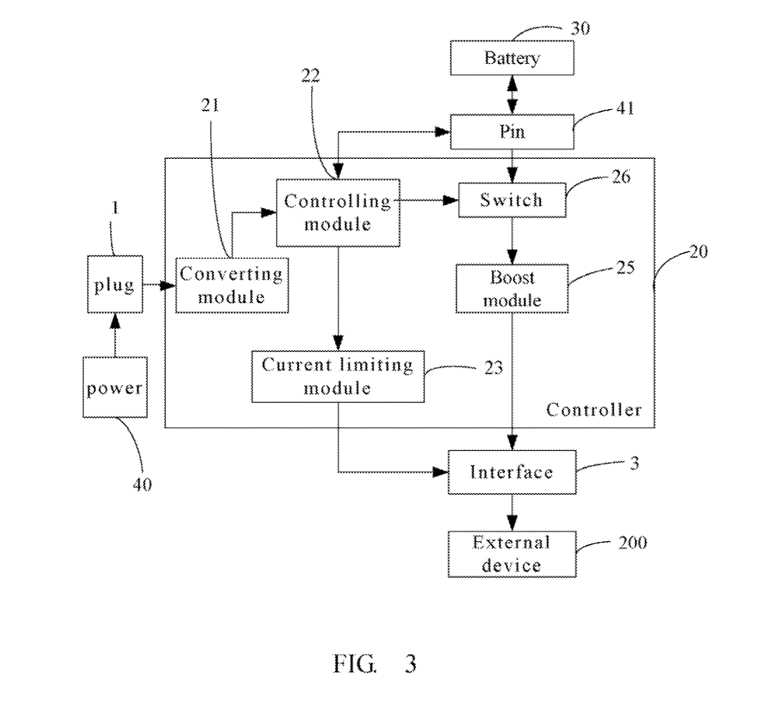

Referring to FIG. 3, in detail, the controller 20 includes a converting module 21, a controlling module 22, a current limiting module 23, a boost module 25, and a switch 26. The converting module 21 is electrically connected between the plug 1 and the controlling module 22. The controlling module 22 is also electrically connected to the pins 41 of the clamp 4, the switch 26, and the current limiting module 23. The switch 26 is also electrically connected between the pins 41 and the boost module 25. Both the current limiting module 23 and the boost module 25 are electrically connected to the interface 3.

When the plug 1 is electrically connected to the power source 40, the converting module 21 converts the power from the power source 40 to proper voltage and current for charging and transmits the converted power to the controlling module 22. The controlling module 22 is also configured to identify the voltage levels at the pins 41 and the interface 3. If the controlling module 22 identifies the pins 41 are at a low voltage level and the interface 3 is at a high voltage level, which means the battery 30 is electrically connected to the pins 41, and the external device 200 is not connected to the charging interface 3, the controlling module 22 closes the first current path 11 to charge the battery 30.

If the controlling module 22 identifies the electric the pins 41 are at a high voltage level and the interface 3 is at a low voltage level, which means the battery 30 is not electrically connected to the pins 41, and the external device 200 is connected to the interface 3, the controlling module 22 closes the second current path to charge the external device 200. After the controlling module 22 closes the second current path, the current limiting module 23 limits the charging current to the external device 200, according to the rated current of the external device 200, to protect the external device 200.

If the controlling module 22 identifies the pins 41 and the interface 3 are both at a low voltage level, which means the battery 30 is electrically connected to the pins 41, and the interface 3 is connected to the external device 200, the controlling module 22 closes the first current path 11 and the second current path 12 to charge the battery 30 and the external device 200, while opening the third current path 13, that is, opens the switch 26 between the pins 41 and the boost module 25.

If the plug 1 is not electrically connected to the power source 40, the battery 30 is electrically connected to the pins 41, and the controlling module 22 indentifies the charging interface 3 is at a low voltage level, which means the external device 200 is connected to the charging interface 3, then the controlling module 22 closes the third current path 13 to transmit power from the battery 30 to the boost module 25. The boost module 25 boosts the battery voltage to a needed level, such as 5V, to charge the external device 200.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A battery charger comprising:
a base;
a plug formed on the base and configured for electrically connecting an external power source;
an interface formed on the base and configured for electrically connecting an external device;
a clamp formed on the base and configured for fixing and electrically connecting a battery; and
a controller embedded in the base and electrically connected to the plug, the clamp, the interface, and configured for boosting the battery voltage to a proper voltage of the external device and conducting the power with the proper voltage to the interface to charge the external device.

2. The battery charger as described in claim 1, wherein the interface is a USB interface.

3. The battery charger as described in claim 1, wherein the base has a receiving area for receiving the battery; when the battery is received in the receiving area correctly, the pins of the clamp abuts the battery and electrically connects the electrodes of the battery.

4. The battery charger as described in claim 1, wherein the controller is configured to convert the power of an external power source to a proper voltage and current.

5. The battery charger as described in claim 1, wherein the controller is configured for limiting a charging current according to the rated current of the external device to protect the external device.

6. The battery charger as described in claim 1, wherein the clamp is pivotedly connected to the base, and the clamp includes a plurality of pins electrically connected to the controller.

7. The battery charger as described in claim 6, wherein the controller is configured to charge the battery if the controller identifies the pins is at a low voltage level and the interface is at a high voltage level.

8. The battery charger as described in claim 6, wherein the controller is configured to charge the external device if the controller identifies the pins is at a high voltage level and the interface is at a low voltage level.

9. The battery charger as described in claim 6, wherein the controller is configured to charge the battery and the external device, and meanwhile stop conducting the power from the battery to the external device via the interface if the controller identifies the pins and the interface both are at a low voltage level.
